(19) United States
(12) Patent Application Publication
(10) Pub. No.: US 2023/0369684 A1
(43) Pub. Date: Nov. 16, 2023

(54) Metal Air Battery

(71) Applicant: Nippon Telegraph and Telephone Corporation, Tokyo (JP)

(72) Inventors: Yuzu Kobayashi, Musashino-shi, Tokyo (JP); Takeshi Komatsu, Musashino-shi, Tokyo (JP); Hiroaki Taguchi, Musashino-shi, Tokyo (JP); Masaya Nohara, Musashino-shi, Tokyo (JP); Mikayo Iwata, Musashino-shi, Tokyo (JP)

(21) Appl. No.: 18/246,649

(22) PCT Filed: Oct. 1, 2020
(86) PCT No.: PCT/JP2020/037472

§ 371 Date: Mar. 24, 2023

(51) Int. Cl. H01M 12/08; H01M 8/1004; H01M 8/1067; H01M 4/86; H01M 8/083

(52) U.S. Cl. CPC H01M 12/08; H01M 8/1004; H01M 8/1067; H01M 4/8626; H01M 8/083; H01M 2004/8684; H01M 2008/1095

(57) ABSTRACT

A metal-air battery includes: an air electrode; a negative electrode; an ion exchange membrane that separates the air electrode and the negative electrode from each other; an air-electrode-side electrolytic solution that is disposed between the air electrode and the ion exchange membrane; and a negative-electrode-side electrolytic solution that is disposed between the negative electrode and the ion exchange membrane. The negative-electrode-side electrolytic solution contains a surfactant.

### TECHNICAL FIELD

The present invention relates to a metal-air battery.

### BACKGROUND ART

Conventionally, alkaline batteries, manganese batteries, and the like have been widely used as disposable primary batteries. Also, along with the recent development of Internet of Things (IoT), the development of scattered sensors to be installed and used in any places in nature such as in the soil or the forest has also progressed, and small and high-performance coin-like lithium primary batteries compatible with various applications such as these sensors have become widespread.

However, most disposable batteries generally used at present are formed with rare metals such as lithium, nickel, manganese, and cobalt, and there is the problem of resource depletion. Also, since strong alkaline electrolytic solutions such as aqueous sodium hydroxides or organic electrolytic solutions are used as the electrolytic solutions, final disposal of those batteries is not easy. Further, in a case where a disposable battery is used as the drive source for a sensor to be buried in the soil, there is a concern about the influence on the surrounding environment, depending on the usage environment.

To solve the problems described above, a metal-air battery can be mentioned as a possibility that can serve as a battery with a low environmental load. In metal-air batteries, oxygen and water are used as the air electrode active materials, and a metal such as magnesium, aluminum, calcium, iron, or zinc is used as the negative electrode active material. Accordingly, the influence on soil contamination and the like, and the influence on ecosystems are also small. Furthermore, these are materials with abundant resources, and are less expensive than rare metals. Such metal-air batteries have been researched and developed as batteries with low environmental loads (see Patent Literature 1).

### CITATION LIST

### Patent Literature

Patent Literature 1: WO 2018/003724 A

### Non Patent Literature

Non Patent Literature 1: M. A. Deyab, “Decyl glucoside as a corrosion inhibitor for magnesiumeair battery”, Journal of Power Sources, vol. 325, pp. 98-103, 2016
Non Patent Literature 2: Salah Eid, “Measurement of Hydrogen Produced during Magnesium Corrosion in Hydrochloric Acid and the Effect of the TritonX-100 Surfactant on Hydrogen Production”, J Surfact Deterg, vol. 22, pp. 153-160, 2019

### SUMMARY OF INVENTION

### Technical Problem

In a metal-air battery, the metal of the negative electrode is consumed by a corrosion reaction at every moment, and only part of the employed metal can be used for battery reactions. It has been reported that corrosion reactions of a metal can be reduced by a surfactant added to an electrolytic solution (see Non Patent Literatures 1 and 2).

However, a surfactant might hydrophilize the air electrode, and submerge the air electrode in the electrolytic solution. The submersion will reduce the length of the three-phase interface, which is the air electrode reaction field, and therefore, the overvoltage on the air electrode side will increase while battery performance deteriorates, resulting in a trade-off problem.

The present invention has been made in view of the above circumstances, and an objective of the present invention is to improve battery performance by reducing corrosion reactions of the negative electrode while minimizing influence on the air electrode.

### Solution to Problem

A metal-air battery that is a mode of the present invention includes: an air electrode; a negative electrode; an ion exchange membrane that separates the air electrode and the negative electrode from each other; an air-electrode-side electrolytic solution that is disposed between the air electrode and the ion exchange membrane; and a negative-electrode-side electrolytic solution that is disposed between the negative electrode and the ion exchange membrane. The negative-electrode-side electrolytic solution contains a surfactant.

### Advantageous Effects of Invention

According to the present invention, it is possible to improve battery performance by reducing corrosion reactions of the negative electrode while minimizing influence on the air electrode.

### BRIEF DESCRIPTION OF DRAWINGS

FIG. 1 is a diagram illustrating a basic configuration of a metal-air battery according to an embodiment of the present invention.

FIG. 2 is a flowchart for explaining Manufacturing Method 1.

FIG. 3 is a flowchart for explaining Manufacturing Method 2.

FIG. 4 is a flowchart for explaining Manufacturing Method 3.

FIG. 5 is a flowchart for explaining Manufacturing Method 4.

FIG. 6 is a flowchart for explaining Manufacturing Methods 5, 6, and 7.

FIG. 7A is a cross-sectional diagram illustrating an example configuration of a coin-cell metal-air battery.

FIG. 7B is a plan view illustrating an example configuration of a coin-cell metal-air battery.

FIG. 8 is a configuration diagram illustrating an example configuration of a metal-air battery.

FIG. 9 is a graph showing a discharge curve in Example 1.

### DESCRIPTION OF EMBODIMENTS

The following is a description of an embodiment of the present invention, with reference to the drawings.

### Configuration of a Metal-Air Battery

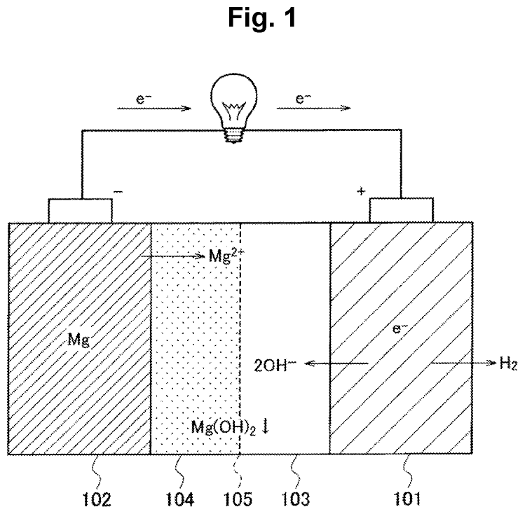

FIG. 1 is a configuration diagram illustrating a basic configuration of a metal-air battery in this embodiment. Note that, although FIG. 1 illustrates a metal-air battery using magnesium for the negative electrode as an example, the present invention is not limited to a magnesium-air battery.

The metal-air battery illustrated in the drawing includes an air electrode 101 that is a positive electrode and is of a gas diffusion type, a negative electrode 102, an electrolytic solution 103 on the air electrode side, an electrolytic solution 104 on the negative electrode side, and an ion exchange membrane 105 that separates the air electrode 101 and the negative electrode 102 from each other. The electrolytic solution 103 is disposed between the air electrode 101 and the ion exchange membrane 105. The electrolytic solution 104 is disposed between the negative electrode 102 and the ion exchange membrane 105. The electrolytic solution 104 of this embodiment contains a surfactant. That is, the surfactant is dissolved in the electrolytic solution 104.

The ion exchange membrane 105 prevents diffusion of the surfactant, and separates the electrolytic solution 103 on the air electrode side and the electrolytic solution 104 on the negative electrode side from each other. One surface of the air electrode 101 is exposed to the atmosphere, and the other surface is in contact with the electrolytic solution 103. The surface of the negative electrode 102 on the side of the electrolytic solution 104 is in contact with the electrolytic solution 104.

### Air Electrode

The air electrode 101 is now described. The air electrode 101 of this embodiment includes a co-continuous body having a three-dimensional network structure in which a plurality of nanostructures is integrated by non-covalent bonding. The co-continuous body is a porous body, and has an integral structure.

The nanostructure are nanosheets, nanofibers, or the like, for example. In the co-continuous body having a three-dimensional network structure in which a plurality of nanostructures is integrated by non-covalent bonding, the bonding portions between the nanostructures are deformable, and the co-continuous body is a stretchable structure.

The nanosheets may contain at least one material selected from the group consisting of carbon, iron oxides, manganese oxides, magnesium oxides, molybdenum oxides, and molybdenum sulfide compounds, for example. Examples of the molybdenum sulfide compounds include molybdenum disulfides and phosphorus-doped molybdenum sulfides. The element of the material of the nanosheets may be any appropriate element that contains at least one of the 16 elements (C, O, H, N, P, K, S, Ca, Mg, Fe, Mn, B, Zn, Cu, Mo, and Cl) essential for the growth of plants.

It is important that the nanosheets have conductivity. A nanosheet is defined as a sheet-like substance that has a thickness of 1 nm to 1 μm, and a planar longitudinal/lateral length 100 or more times greater than the thickness. Examples of carbon nanosheets include graphene. The nanosheets may have a roll-like shape or a wave-like shape, or the nanosheets may be curved or bent, having any appropriate shape.

The nanofibers may contain at least one material selected from the group consisting of carbon, iron oxides, manganese oxides, magnesium oxides, molybdenum oxides, molybdenum sulfides, and cellulose (carbonized cellulose). An element of these materials may be any appropriate element that contains at least one of the 16 elements (C, O, H, N, P, K, S, Ca, Mg, Fe, Mn, B, Zn, Cu, Mo, and Cl) essential for the growth of plants.

It is important that the nanofibers also have conductivity. A nanofiber is defined as a fibrous substance that has a diameter of 1 nm to 1 μm, and a length 100 or more times greater than the diameter. Also, a nanofiber may have a hollow shape, a coil-like shape, or any other appropriate shape. Note that the cellulose to be used is carbonized to have conductivity as described later.

For example, a sol or gel in which nanostructures are dispersed is frozen to obtain a frozen material (the freezing step), and the frozen material is dried in vacuum (the drying step). By doing so, it is possible to create the co-continuous body to be the air electrode 101. A gel in which nanofibers containing at least one of iron oxides, manganese oxides, silicon, and cellulose are dispersed can be created by predetermined bacteria (the gel producing step).

Alternatively, a gel in which nanofibers formed with cellulose are dispersed may be produced by predetermined bacteria (the gel producing step), and this gel may be carbonized by heating in an inert gas atmosphere so that the co-continuous body is obtained (the carbonizing step).

The co-continuous body forming the air electrode 101 preferably has an average pore size of 0.1 to 50 μm, or more preferably 0.1 to 2 μm, for example. Here, the average pore size is a value measured by a mercury intrusion technique.

In the air electrode 101 using such a co-continuous body, an additional material such as a binder required in the case of an air electrode using carbon powder is unnecessary, which is advantageous in terms of cost and environment.

### Negative Electrode

Next, the negative electrode 102 is described. The negative electrode 102 contains at least one element selected from the group consisting of magnesium, zinc, aluminum, iron, and calcium. Specifically, the negative electrode 102 is formed with a negative electrode active substance. This negative electrode active substance is not limited to any specific substance, as long as it is a material that can be used as the negative electrode material of a metal-air battery, or is at least one metal selected from the group consisting of magnesium, zinc, aluminum, iron, and calcium. Alternatively, the negative electrode active substance may be an alloy containing at least one metal selected from the above group as a principal component. For example, the negative electrode 102 may be formed with a metal serving as a negative electrode, a sheet of metal, or a material obtained by pressure-bonding powder to metal foil such as copper foil.

The negative electrode 102 can be formed by a known technique. For example, in a case where a magnesium metal is used as the negative electrode 102, it is possible to create the negative electrode 102 by forming a plurality of sheets of metal magnesium foil in a predetermined shape in an overlapping manner.

### Electrolytic Solution

Next, the electrolytic solutions 103 and 104 are described. The electrolytic solution 103 on the air electrode side may be a gel electrolytic solution containing an ion conductor capable of moving hydroxide ions between the air electrode 101 (the positive electrode) and the negative electrode 102. As the ion conductor forming the electrolytic solution 103, a metal salt containing potassium or sodium abundantly present on the earth can be used, for example. Note that the metal salt may be formed with the 16 elements (C, O, H, N, P, K, S, Ca, Mg, Fe, Mn, B, Zn, Cu, Mo, and Cl) essential for the growth of plants, elements contained in seawater or rainwater, or the like.

The electrolytic solution 103 is only required to be formed with at least one material selected from the group consisting of chlorides such as sodium chlorides and potassium chlorides, acetates, carbonates, citrates, phosphates, HEPES (4-(2-hydroxyethyl)-1-piperazineethanesulfonic acid), pyrophosphates, and metaphosphates, for example. Also, the electrolytic solution 103 may be formed with a mixture of some of these materials. The ion conductor can be dissolved in ion-exchange water at a concentration of 0.1 to 10 mol/L, or preferably at a concentration of 0.1 to 2 mol/L, to form the electrolytic solution 103.

The electrolytic solution 104 on the negative electrode side is obtained by dissolving a surfactant in the solution (the electrolytic solution 103) that is the same as the electrolytic solution 103 at a concentration of 1×10⁻⁵ to 1 mol/L. The surfactant is not limited to any specific surfactant, but a non-ionic surfactant that is unlikely to affect battery reactions is preferable. Specifically, the surfactant contains at least one material selected from the group consisting of octylphenol ethoxylate, polyoxyethylene sorbitan monooleate, alkyl glucoside, methyl tri-n-octylammonium chloride, sodium lauryl sulfate, and N-lauroyl sarcosine, which reduce corrosion reactions of the metal used for the negative electrode, such as magnesium or zinc. As the surfactant is dissolved, corrosion reactions of the negative electrode 102 can be reduced, and battery performance is enhanced.

### Ion Exchange Membrane

The ion exchange membrane 105 separates the air electrode 101 and the negative electrode from each other. The ion exchange membrane 105 of this embodiment is disposed so as to separate the electrolytic solution 103 and the electrolyte 104 from each other. Various kinds of known materials can be used for the ion exchange membrane 105. The ion exchange membrane 105 preferably contains at least two kinds selected from the group consisting of carbon atoms, hydrogen atoms, oxygen atoms, nitrogen atoms, sulfur atoms, sodium atoms, potassium atoms, and phosphorus atoms. The ion exchange membrane 105 of this embodiment allows permeation of only hydroxide ions, and reduces diffusion (migration) of the surfactant contained in the electrolyte 104 into the electrolytic solution 103 on the air electrode side.

In this embodiment, a surfactant is added only to the electrolytic solution 104 on the negative electrode side, and the ion exchange membrane 105 that reduces diffusion of the surfactant is provided between the electrolytic solution 104 and the electrolytic solution 103 on the air electrode side. With this arrangement, it is possible to prevent the surfactant from diffusing into the electrolytic solution 103 on the air electrode side, hydrophilizing the air electrode 101, submerging the air electrode 101 in the electrolyte 103, and lowering the battery voltage in this embodiment.

### Other Components

Note that, in addition to the above components, the metal-air battery can include structural members such as a separator, a battery case, and a metallic mesh (a copper mesh, for example), and any components required for the metal-air battery. Conventionally components can be used for these. The separator is not limited to any specific one as long as the separator is formed with a fiber material, but a cellulose-based separator formed with plant fibers or bacteria is particularly preferable.

### Manufacturing Method

Next, a method for manufacturing the metal-air battery is described. It is possible to manufacture the metal-air battery of this embodiment by appropriately disposing the air electrode 101, the negative electrode 102, the electrolytic solutions 103 and 104, and the ion exchange membrane 105, together with other necessary components based on the desired metal-air battery structure, in a suitable container such as a case. In these procedures for manufacturing the metal-air battery, conventionally known methods can be used.

Methods for manufacturing the electrolytic solutions 103 and 104, and the air electrode 101 are described below.

### Manufacturing Method 1 (Electrolytic Solution Manufacturing Method)

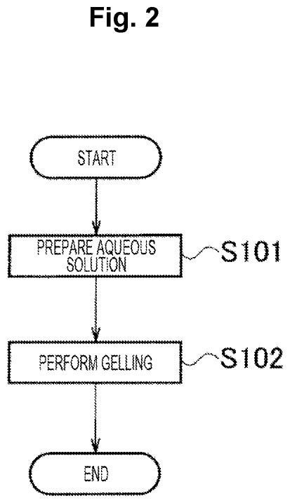

First, Manufacturing Method 1 for manufacturing the electrolytic solution 103 is described with reference to FIG. 2.

FIG. 2 is a flowchart for explaining Manufacturing Method 1. First, in step S101, an electrolytic ion conductor is dissolved in ion-exchange water, to prepare an aqueous solution. Next, in step S102, a gelling agent is added to the prepared aqueous solution. The gelling agent can be a plant-derived polysaccharide (corn starch, potato starch, tapioca starch, dextrin, tamarin seed gum, guar gum, locust bean gum, gum arabic, karaya gum, pectin, cellulose, konjac mannan, or soybean polysaccharide), a seaweed-derived polysaccharide (carrageenan, agar, or alginic acid), a microorganism-derived polysaccharide (xanthan gum, gellan gum, Agrobacterium succinoglycan, or cellulose), an animal-derived polysaccharide (chitin, chitosan, or gelatin), or the like.

The weight percent of the gelling agent is only required to be 0.01 to 90%, or preferably 0.01 to 20%, with respect to the aqueous solution of the ionic conductor. The ion conductor is only required to be formed with at least one material selected from the group consisting of chlorides, acetates, carbonates, citrates, phosphates, HEPES (4-(2-hydroxyethyl)-1-piperazineethanesulfonic acid), pyrophosphates, and metaphosphates.

When the gelling agent is added to a solvent at about 50° C. to 90° C., molecules of the gelling agent sufficiently swell and scatter. As the temperature of the solvent drops, the molecules are entangled with each other, to form cross-linking points. As many cross-linking points are formed, the gelling agent has a mesh-like structure, and the solvent turns into a gel. The dissolution temperature (50 to 90° C.) required to dissolve the gelling agent, and the cooling temperature (10 to 80° C.) required for gelling vary with the gelling agent being used.

The electrolytic solution 104 is manufactured by dissolving a surfactant in an electrolytic solution prepared in the same manner as the electrolytic solution 103.

### Manufacturing Method 2 (Air Electrode Manufacturing Method)

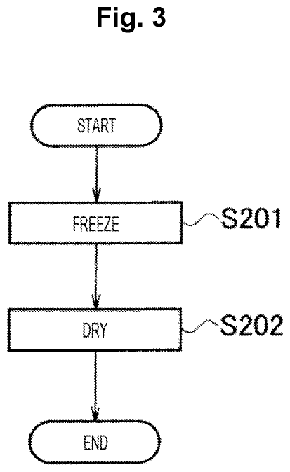

Next, Manufacturing Method 2 for manufacturing the air electrode 101 is described with reference to FIG. 3.

FIG. 3 is a flowchart for explaining Manufacturing Method 2. First, in step S201, a sol or gel in which nanostructures such as nanosheets or nanofibers are dispersed is frozen, to obtain a frozen material (the freezing step). Next, in step S202, the obtained frozen material is dried in vacuum, to obtain a co-continuous body (the drying step). In the description below, each step is described in greater detail.

The freezing step in step S201 is a step of maintaining or constructing a three-dimensional network structure, using the nanostructures to be the raw material of the co-continuous body having stretchability. The co-continuous body has a three-dimensional network structure in which a plurality of nanostructures is integrated by non-covalent bonding.

Here, a gel means a solid in which nanostructures having a dispersion medium as a dispersoid have lost fluidity due to a three-dimensional network structure. Specifically, a gel means a dispersion system having a shear elastic modulus of 102 to 106 Pa. The dispersion medium of a gel is an aqueous system such as water (H₂O), or an organic system such as carboxylic acid, methanol (CH₃OH), ethanol (C₂H₅OH), propanol (C₃H₇OH), n-butanol, isobutanol, n-butylamine, dodecane, unsaturated fatty acid, ethylene glycol, heptane, hexadecane, isoamyl alcohol, octanol, isopropanol, acetone, or glycerin. Two or more of these may be mixed.

Next, a sol means a colloid formed with a dispersion medium and nanostructures that are the dispersoid. Specifically, a sol means a dispersion system having a shear elastic modulus of 1 Pa or lower. The dispersion medium of a sol is an aqueous system such as water, or an organic system such as carboxylic acid, methanol, ethanol, propanol, n-butanol, isobutanol, n-butylamine, dodecane, unsaturated fatty acid, ethylene glycol, heptane, hexadecane, isoamyl alcohol, octanol, isopropanol, acetone, or glycerin. Two or more of these may be mixed.

The freezing step is carried out by storing a sol or gel in which nanostructures are dispersed in an appropriate container such as a test tube, and cooling the periphery of the test tube in a coolant such as liquid nitrogen to freeze the sol or gel stored in the test tube, for example. The technique for freezing is not limited to any specific technique, as long as the dispersion medium of the gel or sol can be cooled to a temperature equal to or lower than the freezing point. The dispersion medium may be cooled in a freezer or the like.

As the gel or sol is frozen, the dispersion medium loses its fluidity, the dispersoid is fixed, and a three-dimensional network structure is constructed. Also, in the freezing step, it is possible to freely adjust the specific surface area by controlling the concentration of the gel or sol. The lower the concentration of the gel or sol, the higher the specific surface area of the resultant co-continuous body. However, if the concentration is 0.01 wt % or lower, it is difficult for the dispersoid to form a three-dimensional network structure. Therefore, the concentration of the dispersoid is preferably 0.01 to 10 wt %.

As a three-dimensional network structure having a high specific surface area is formed with nanostructures such as nanofibers or nanosheets, pores play a role of a cushion during compression or tension, and have an excellent stretchability. Specifically, the co-continuous body preferably has a strain of 5% or higher at the elasticity limit, or more preferably has a strain of 10% or higher.

Note that, in a case where the dispersoid is not fixed in the freezing step, the dispersoid is aggregated as the dispersion medium evaporates in the subsequent drying step. Therefore, a sufficiently high specific surface area cannot be obtained, and it is difficult to prepare a co-continuous body having a three-dimensional network structure.

Next, the drying step in step S202 is described. The drying step is a step of taking out the dispersoid (a plurality of microscopic structures that are integrated) maintaining or forming the three-dimensional network structure from the dispersion medium from the frozen material obtained in the freezing step.

In the drying step, the frozen material obtained in the freezing step is dried in vacuum, and the frozen dispersion medium is sublimated from the solid state. The drying step is carried out by storing the obtained frozen material in an appropriate container such as a flask, and vacuuming the inside of the container, for example. As the frozen material is placed in a vacuum atmosphere, the sublimation point of the dispersion medium drops, and even a substance that is not sublimated at ordinary pressure can be sublimated.

The degree of vacuum in the drying step varies with the dispersion medium being used, but is not limited to any specific degree as long as the dispersion medium sublimates. For example, in a case where water is used as the dispersion medium, the degree of vacuum needs to be set so that the pressure becomes 0.06 MPa or lower. However, heat is taken away as latent heat of sublimation, and therefore, drying takes time. In view of this, the degree of vacuum is preferably 1.0×10⁻⁶ to 1.0×10⁻² Pa. Furthermore, heat may be applied from a heater or the like during the drying.

By a method for drying in the atmosphere, the dispersion medium changes from a solid to a liquid, and then changes from the liquid to a gas. Therefore, the frozen material enters a liquid state and becomes fluid again in the dispersion medium, and the three-dimensional network structure of the plurality of nanostructures collapses. Because of this, it is difficult to produce a co-continuous body having stretchability by drying in an atmosphere at an atmospheric pressure.

Note that, in a case where the nanostructures are cellulose nanofibers, a carbonizing step (not shown) is performed, and the co-continuous body obtained in the drying step is carbonized to achieve conductivity. On the other hand, in a case where the nanostructures are not cellulose nanofibers, the carbonizing step is not necessary.

Carbonization of the co-continuous body may be performed by burning the co-continuous body at 200° C. to 2000° C., or more preferably at 600° C. to 1800° C., in an inert gas atmosphere. The gas in which cellulose nanofibers do not burn may be an inert gas such as a nitrogen gas or an argon gas, for example. Alternatively, the gas may be a reducing gas such as a hydrogen gas or a carbon monoxide gas, or may be a carbon dioxide gas.

### Manufacturing Method 3 (Air Electrode Manufacturing Method)

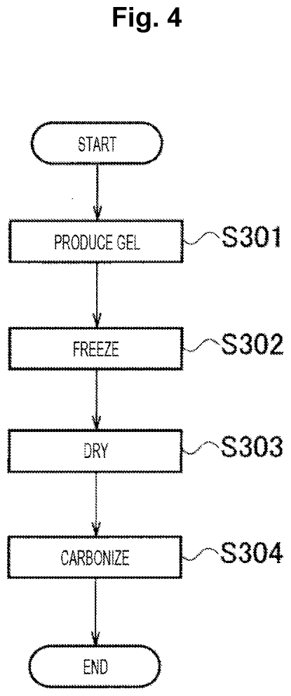

Next, Manufacturing Method 3 that is another method for manufacturing the air electrode 101 is described with reference to FIG. 4.

FIG. 4 is a flowchart for explaining Manufacturing Method 3. First, in step S301, a gel in which nanofibers formed with an iron oxide, a manganese oxide, or cellulose are dispersed is produced in predetermined bacteria (the gel producing step). Using the gel obtained in this manner, a co-continuous body is prepared.

The gel produced by bacteria has fibers on the order of nm as a basic structure. As a co-continuous body is produced with this gel, the resultant co-continuous body has a high specific surface area. As described above, since the air electrode of a metal-air battery preferably has a high specific surface area, it is preferable to use a gel produced by bacteria. Specifically, as a gel produced by bacteria is used, it is possible to synthesize an air electrode (a co-continuous body) having a specific surface area of 300 m²/g or higher.

Since the gel produced by bacteria has a structure in which fibers are entangled in a coil-like or mesh-like manner, and further has a structure in which nanofibers are branched on the basis of growth of bacteria, the co-continuous body that can be manufactured will achieve excellent stretchability with a strain of 50% or higher at the elasticity limit. Accordingly, the co-continuous body manufactured with the gel produced by bacteria is suitable for the air electrode of a metal-air battery.

To obtain the gel produced by bacterium, two or more kinds among bacterial cellulose, iron oxides, and manganese oxides may be mixed.

The bacteria are known bacteria, and examples of the bacteria include acetic acid bacteria such as Acetobacter xylinum subspecies sucrofermentans, Acetobacter xylinum ATCC23768, Acetobacter xylinum ATCC23769, Acetobacter pasteurianus ATCC10245, Acetobacter xylinum ATCC14851, Acetobacter xylinum ATCC11142, or Acetobacter xylinum ATCC10821, Agrobacterium, Rhizobium, Sarcina, Pseudomonas, Achromobacter, Alcaligenes, Aerobacter, Azotobacter, Zooglea, Enterobacter, Kluyvera, Leptothrix, Gallionella, Siderocapsa, Thiobacillus, and those produced by cultivating various mutant strains created by subjecting the above bacteria to a mutation treatment by a known method using nitrosoguanidine (NTG) or the like.

As for a method for obtaining a co-continuous body using the gel produced by bacteria as described above, it is only required to freeze the gel in step S302 to obtain a frozen material (the freezing step), and dry the frozen material in vacuum in step S303 to obtain a co-continuous body (the drying step), as in Manufacturing Method 2. However, in a case where a gel in which nanofibers formed with cellulose produced by bacteria are dispersed, the prepared co-continuous body is heated and carbonized in a gas atmosphere in which cellulose does not burn in step S304 (the carbonizing step).

Bacterial cellulose, which is a component contained in the gel produced by bacteria, does not have electrical conductivity. Therefore, when the gel produced by bacteria is used as the air electrode, it is important to perform the carbonizing step in which the gel produced by bacteria is carbonized through a heat treatment in an inert gas atmosphere to provide electrical conductivity. The co-continuous body carbonized in this manner has a high conductivity, a corrosion resistance, a high stretchability, and a high specific surface area, and is suitable as the air electrode of a metal-air battery.

The carbonization of bacterial cellulose may be performed by synthesizing a co-continuous body that is formed with bacteria cellulose and has a three-dimensional network structure in the freezing step and the drying step described above, and then burning the co-continuous body at 500° C. to 2000° C., or more preferably at 900° C. to 1800° C., in an inert gas atmosphere to carbonize the co-continuous body. The gas in which cellulose does not burn may be an inert gas such as a nitrogen gas or an argon gas, for example. Alternatively, the gas may be a reducing gas such as a hydrogen gas or a carbon monoxide gas, or may be a carbon dioxide gas. In this embodiment, a carbon dioxide gas or a carbon monoxide gas that has an activating effect on carbon materials and can be expected to greatly activate the co-continuous body is more preferable.

In the description below, methods for supporting a catalyst on the air electrode 101 are described as Manufacturing Methods 4 to 7.

### Manufacturing Method 4 (Method for Supporting a Catalyst on the Air Electrode)

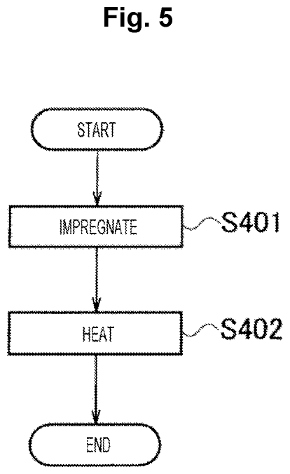

Next, Manufacturing Method 4, which is a method for supporting a catalyst on the air electrode 101, is described with reference to FIG. 5.

FIG. 5 is a flowchart for explaining Manufacturing Method 4. A catalyst may be supported on the air electrode 101. In step S401, a co-continuous body obtained by Manufacturing Method 2 or Manufacturing Method 3 described above is impregnated with an aqueous solution of the metal salt that is the precursor of the catalyst (the impregnating step). After a stretchable co-continuous body containing the metal salt is prepared in this manner, the stretchable co-continuous body containing the metal salt is next subjected to a heat treatment in step S402 (the heating step). Note that a preferred metal for the metal salt to be used is at least one metal selected from the group consisting of iron, manganese, zinc, copper, and molybdenum. Particularly, manganese is preferable.

To support a transition metal oxide on the co-continuous body, a conventional known method can be used. For example, there is a method by which, after impregnated with an aqueous solution of a transition metal chloride or a transition metal nitrate, a co-continuous body evaporates to dryness, and is then subjected to hydrothermal synthesis in water (H₂O) under high temperature and pressure. Also, there is a precipitation method by which a co-continuous body is impregnated with an aqueous solution of a transition metal chloride or a transition metal nitrate, and an alkaline aqueous solution is added dropwise thereto. Further, there is a sol-gel method by which a co-continuous body is impregnated with a transition metal alkoxide solution, and is hydrolyzed. The conditions for each of these methods according to liquid phase methods are known, and these known conditions can be applied. In this embodiment, a liquid phase method is preferable.

In many cases, a metal oxide supported by the above liquid phase methods is in an amorphous state, because crystallization thereof has not progressed. The precursor in an amorphous state is subjected to a heat treatment in an inert atmosphere at a high temperature of about 500° C., so that a crystalline metal oxide can be obtained. Such a crystalline metal oxide exhibits high performance even in a case where it is used as the catalyst for the air electrode.

On the other hand, the precursor powder obtained in a case where the amorphous precursor described above is dried at a relatively low temperature of about 100 to 200° C. is in the form of a hydrate while maintaining an amorphous state. A hydrate of a metal oxide can be formally expressed as MexOyn·H₂O (where Me means the above metal, x and y each represent the number of metal and oxygen molecules included the metal oxide molecules, and n represents the number of moles of H₂O with respect to 1 mol of the metal oxide). The hydrate of the metal oxide obtained through such low-temperature drying can be used as the catalyst.

Having been hardly sintered, the amorphous metal oxide (the hydrate) has a large surface area, and a very small particle size of about 30 nm. This is suitable as a catalyst, and the use of this catalyst will lead to excellent battery performance.

As described above, a crystalline metal oxide exhibits high activity, but the surface area of the metal oxide crystallized through a high-temperature heat treatment as described above might decrease significantly, and the particle size might become about 100 nm due to aggregation of particles. Note that this particle size (the average particle size) is the value obtained by enlarging and observing particles with a scanning electron microscope (SEM) or the like, measuring the diameter of the particles per 10 μm square (10 μm×10 μm), and calculating the average value.

Further, particularly in the case of a catalyst formed with a metal oxide subjected to a heat treatment at a high temperature, the particles aggregate, and therefore, it might be difficult to add the catalyst to the surface of the co-continuous body with high dispersion. To achieve a sufficient catalytic effect, it is necessary to add a large amount of metal oxide to the air electrode (a co-continuous body) in some cases, and production of a catalyst through a heat treatment at a high temperature might be disadvantageous in terms of cost.

To solve this problem, Manufacturing Method 5, Manufacturing Method 6, or Manufacturing Method 7 described below should be used.

### Manufacturing Method 5 (Method for Supporting a Catalyst on the Air Electrode)

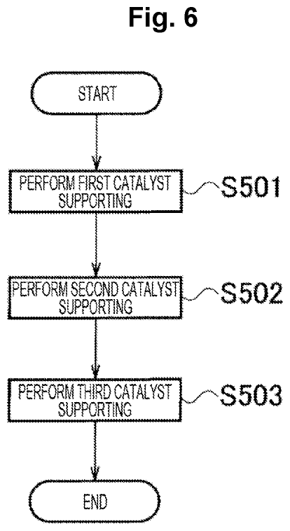

Next, Manufacturing Method 5, which is a method for supporting a catalyst on the air electrode, is described with reference to FIG. 6.

FIG. 6 is a flowchart for explaining Manufacturing Methods 5, 6, and 7. By Manufacturing Method 5, a catalyst is supported on a co-continuous body manufactured by Manufacturing Method 2 or Manufacturing Method 3. Manufacturing Method 5 includes the catalyst supporting steps described below for supporting a catalyst, in addition to the co-continuous body manufacturing described above.

First, in the first catalyst supporting step in step S501, the co-continuous body is immersed in an aqueous solution of a surfactant, so that the surfactant is made to adhere to the surface of the co-continuous body.

Next, in the second catalyst supporting step in step S502, an aqueous solution of a metal salt is used, so that, because of the surfactant, the metal salt is made to adhere to the surface of the co-continuous body having the surfactant adhering thereto.

Next, in the third catalyst supporting step in step S503, a heat treatment is performed on the co-continuous body having the metal salt adhering thereto, so that the catalyst formed with the metal (or the metal oxide) forming the metal salt is supported on the co-continuous body.

Note that the above metal is at least one metal selected from the group consisting of iron, manganese, zinc, copper, and molybdenum, or a metal oxide formed with at least one metal selected from the group consisting of calcium, iron, manganese, zinc, copper, and molybdenum. Particularly, manganese (Mn) or manganese oxide (MnO₂) is preferable.

The surfactant that is used in the first catalyst supporting step of Manufacturing Method 5 is for supporting a metal or a transition metal oxide with high dispersion on the air electrode (the co-continuous body). When a hydrophobic group that adsorbs onto a carbon surface and a hydrophilic group to which transition metal ions adsorb are contained in molecules as in a surfactant, metal ions as the transition metal oxide precursor can be made to adsorb to the co-continuous body with a high degree of dispersion.

The surfactant described above is not limited to any specific one, as long as it contains a hydrophobic group that adsorbs to a carbon surface and a hydrophilic group to which manganese ions adsorb in the molecules. However, a non-ionic surfactant is preferable. Examples of ester surfactants include glyceryl laurate, glyceryl monostearate, sorbitan fatty acid ester, and sucrose fatty acid ester. Also, examples of ether surfactants include polyoxyethylene alkyl ether, polyoxyethylene alkylphenyl ether, and polyoxyethylene polyoxypropylene glycol.

Further, examples of ester ether surfactants include polyoxyethylene sorbitan fatty acid ester, polyoxyethylene hexitane fatty acid ester, and sorbitan fatty acid ester polyethylene glycol. Also, examples of alkanolamide surfactants include lauramide and cocamide DEA. Further, examples of higher alcohol surfactants include cetanol, stearyl alcohol, and oleyl alcohol. Also, examples of poloxamer surfactants include poloxamer dimethacrylate.

The concentration of the surfactant in the aqueous solution in the first catalyst supporting step of Manufacturing Method 5 is preferably 0.1 to 20 g/L. Also, the immersion conditions such as immersion time and immersion temperature include immersion in a solution at a temperature between room temperature and 50° C. for one to 48 hours, for example.

The second catalyst supporting step of Manufacturing Method 5 includes further dissolving a metal salt functioning as a catalyst or adding an aqueous solution of a metal salt to the aqueous solution containing the surfactant in the first catalyst supporting step. Alternatively, separately from the aqueous solution containing the surfactant, an aqueous solution in which a metal salt functioning as a catalyst is dissolved may be prepared, and the co-continuous body impregnated with the surfactant (or having the surfactant adhering thereto) may be immersed in the aqueous solution.

Also, the co-continuous body to which the surfactant adheres may be impregnated with the aqueous solution in which the metal salt is dissolved. If necessary, an alkaline aqueous solution may be added dropwise to the resultant co-continuous body containing the metal salt (or having the metal salt adhering thereto). As a result, the metal or the metal oxide precursor can be made to adhere to the co-continuous body.

The amount of addition of the metal salt in the second catalyst supporting step of Manufacturing Method 5 is preferably 0.1 to 100 mmol/L. Also, the immersion conditions such as immersion time and immersion temperature include immersion in a solution at a temperature between room temperature and 50° C. for one to 48 hours, for example.

More specifically, taking manganese as an example of the metal, a manganese metal salt (a manganese halide such as a manganese chloride, a hydrate thereof, or the like, for example) is added to the aqueous solution that contains the surfactant and with which the co-continuous body is impregnated. An alkaline aqueous solution is then added dropwise to the obtained co-continuous body containing the manganese metal salt, so that a manganese hydroxide as the metal or the metal oxide precursor can be supported on the co-continuous body.

The supported amount of the catalyst formed with the manganese oxide described above can be adjusted with the concentration of the metal salt (a manganese chloride, for example) in the metal salt aqueous solution.

Further, examples of the alkali to be used in the alkaline aqueous solution include hydroxides of an alkali metal or an alkaline earth metal, ammonia water, ammonium aqueous solutions, and tetramethylammonium hydroxide (TMAH) aqueous solutions. The concentration of these alkaline aqueous solutions is preferably 0.1 to 10 mol/L.

In the third catalyst supporting step in Manufacturing Method 5, the metal or metal oxide precursor (the metal salt) adhering to the surface of the co-continuous body is converted into the metal or the metal oxide through a heat treatment.

Specifically, the co-continuous body to which the precursor adheres may be dried at a temperature between room temperature (about 25° C.) and 150° C., or more preferably at 50° C. to 100° C., for one to 24 hours, and is then subjected to a heat treatment at 100 to 600° C., or preferably at 110 to 300° C.

In the third catalyst supporting step in Manufacturing Method 5, a heat treatment is performed in an inert atmosphere of argon, helium, nitrogen, or the like, or in a reducing atmosphere, so that an air electrode formed with a co-continuous body having a metal adhering as the catalyst to its surface can be manufactured. Alternatively, a heat treatment is performed in an oxygen-containing gas (an oxidizing atmosphere), so that an air electrode formed with a co-continuous body having a metal oxide adhering as the catalyst to its surface can be manufactured.

Also, it is also possible to manufacture an air electrode formed with a co-continuous body having a metal oxide adhering as the catalyst thereto, by performing a heat treatment under the above-described reductive conditions to once prepare a co-continuous body to which a metal adheres as the catalyst, and then subjecting the co-continuous body to a heat treatment in an oxidizing atmosphere.

By another method, a co-continuous body to which a metal or metal oxide precursor (a metal salt) adheres may be dried at a temperature between room temperature and 150° C., or more preferably at 50° C. to 100° C., and the metal may adhere as the catalyst onto the co-continuous body, to prepare a metal/co-continuous body composite.

In Manufacturing Method 5, the amount of adhesion (content) of the catalyst formed with a metal or a metal oxide is 0.1 to 70 wt o, or preferably 1 to 30 wt o, on the basis of the total weight of the co-continuous body and the catalyst.

By Manufacturing Method 5, it is possible to manufacture an air electrode in which a catalyst formed with a metal or a metal oxide is dispersed at a high concentration on the surface of a co-continuous body, and thus, it is possible to form a metal-air battery having excellent electrical characteristics.

### Manufacturing Method 6 (Method for Supporting a Catalyst on the Air Electrode)

Next, Manufacturing Method 6, which is a method for supporting a catalyst on the air electrode, is described. According to Manufacturing Method 6, a catalyst is supported on a co-continuous body manufactured by Manufacturing Method 2 or Manufacturing Method 3, by a different method different from Manufacturing Method 5 described above. Manufacturing Method 6 includes catalyst supporting steps for supporting a catalyst on the co-continuous body described above.

In the first catalyst supporting step, the co-continuous body is immersed in an aqueous solution of a metal salt, so that the metal salt adheres to the surface of the co-continuous body.

Next, in the second catalyst supporting step, a heat treatment is performed on the co-continuous body having the metal salt adhering thereto, so that the catalyst formed with the metal forming the metal salt is supported on the co-continuous body.

Next, in the third catalyst supporting step, the co-continuous body on which the catalyst is supported is caused to act on high-temperature and high-pressure water, to turn the catalyst into a hydrate of a metal oxide.

Note that the metal (or the metal oxide) forming the metal salt is at least one metal selected from the group consisting of iron, manganese, zinc, copper, and molybdenum, or a metal oxide formed with at least one metal selected from the group consisting of calcium, iron, manganese, zinc, copper, and molybdenum. Particularly, manganese (Mn) or manganese oxide (MnO₂) is preferable.

In the first catalyst supporting step in Manufacturing Method 6, an aqueous solution of the metal salt to be the metal or metal oxide precursor that will be the catalyst in the end is made to adhere to (supported by) the surface of the co-continuous body. For example, an aqueous solution in which the metal salt is dissolved is separately prepared, and the co-continuous body is impregnated with the aqueous solution. The impregnation conditions and the like are the same as those in conventional cases as described above.

The second catalyst supporting step in Manufacturing Method 6 is the same as the third catalyst supporting step of Manufacturing Method 5, and a heat treatment in an inert atmosphere or a reducing atmosphere is performed. Alternatively, by the method described as another method in the third catalyst supporting step of Manufacturing Method 5, the co-continuous body to which the precursor adheres may be subjected to a heat treatment (dried) at a low temperature (room temperature to 150° C., or more preferably 50° C. to 100° C.), to cause the metal to adhere to the co-continuous body.

The air electrode 101 using a metal as the catalyst exhibits a high activity. However, since the catalyst is a metal, the air electrode 101 is weak against corrosion, and lacks long-term stability in some cases. On the other hand, the metal is subjected to a heat treatment to form a hydrate of a metal oxide in the third catalyst supporting step of Manufacturing Method 6 described below in detail, and thus, long-term stability can be achieved.

In the third catalyst supporting step of Manufacturing Method 6, a hydrate of a metal oxide adheres to the co-continuous body. Specifically, the co-continuous body having the metal adhering thereto as obtained in the second catalyst supporting step of Manufacturing Method 6 is immersed in high-temperature and high-pressure water, and the adhering metal is converted into a catalyst formed with a hydrate of a metal oxide.

For example, the co-continuous body having the metal adhering thereto may be immersed in water at 100° C. to 250° C., or more preferably at 150° C. to 200° C., and the adhering metal is oxidized and is turned into a hydrate of a metal oxide.

Since the boiling point of water at atmospheric pressure (0.1 MPa) is 100° C., the co-continuous body cannot be immersed in water at 100° C. or higher at atmospheric pressure normally. However, with the use of a predetermined sealed container, the pressure in the sealed container is increased to 10 to 50 MPa, or preferably to about 25 MPa, for example, so that the boiling point of water can be increased in the sealed container, and liquid water at 100° C. to 250° C. can be obtained. As the co-continuous body having a metal adhering thereto is immersed in the high-temperature water obtained in this manner, the metal can be turned into a hydrate of a metal oxide.

### Manufacturing Method 7 (Method for Supporting a Catalyst on the Air Electrode)

Next, Manufacturing Method 7, which is a method for supporting a catalyst on the air electrode, is described. According to Manufacturing Method 7, a catalyst is supported on a co-continuous body manufactured by Manufacturing Method 2 or Manufacturing Method 3, by a different method different from Manufacturing Methods 5 and 6 described above. Manufacturing Method 7 includes the first catalyst supporting step and the second catalyst supporting step described below for supporting a catalyst on the co-continuous body described above.

In the first catalyst supporting step, the co-continuous body is immersed in an aqueous solution of a metal salt, so that the metal salt adheres to the surface of the co-continuous body. The first catalyst supporting step in Manufacturing Method 7 is the same as the first catalyst supporting step in Manufacturing Method 6, and therefore, explanation thereof is not made herein.

Next, in the second catalyst supporting step, the precursor (the metal salt) adhering to the surface of the co-continuous body is converted into a hydrate of a metal oxide through a heat treatment at a relatively low temperature.

Specifically, the co-continuous body to which the precursor adheres is made to act on high-temperature and high-pressure water, and is then dried at a relatively low temperature of about 100 to 200° C. As a result, the precursor turns into a hydrate in which water molecules are present among the particles, while the amorphous state of the precursor is maintained. The hydrate of the metal oxide obtained through such low-temperature drying is used as the catalyst.

Note that the above metal is at least one metal selected from the group consisting of iron, manganese, zinc, copper, and molybdenum.

In the air electrode manufactured by Manufacturing Method 7, the hydrate of the metal oxide can be supported with high dispersion in the form of nano-sized fine particles on the co-continuous body. Accordingly, in a case where such a co-continuous body is used as the air electrode, excellent battery performance can be exhibited.

A co-continuous body obtained by any of the above manufacturing methods can be formed into a predetermined shape by a known procedure, and be turned into an air electrode. For example, a co-continuous body not supporting a catalyst and a co-continuous body supporting a catalyst may be processed into a plate-like body or a sheet, and the obtained co-continuous body may be cut out in a circular shape having a desired diameter (23 mm, for example) with a punching blade, a laser cutter, or the like, to form an air electrode.

### EXAMPLES

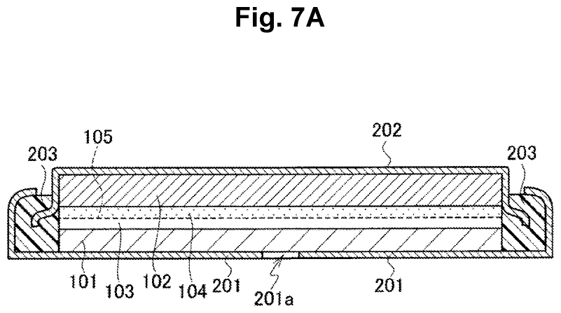

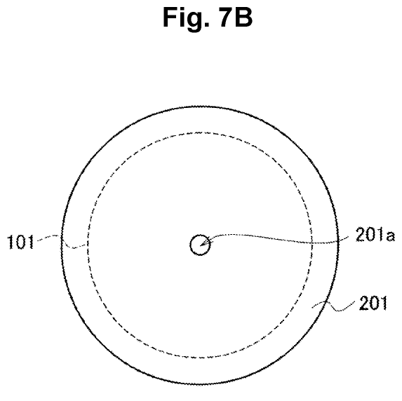

In the description below, the metal-air battery of this embodiment is described in greater detail through Examples. First, the configuration of a battery actually used is described with reference to FIGS. 7A and 7B. FIG. 7A is a cross-sectional diagram illustrating a more specific example configuration of a coin-cell metal-air battery. FIG. 7B is a plan view illustrating the example configuration of the coin-cell metal-air battery.

A metal-air battery using the air electrode 101, the negative electrode 102, the electrolytic solutions 103 and 104, and the ion exchange membrane 105 of the above-described embodiment can be manufactured in a conventional shape such as a coin-like shape, a cylindrical shape, or a laminated shape. The method for manufacturing these batteries can be a method similar to a conventional method.

As illustrated in FIGS. 7A and 7B, the coin cell battery includes the air electrode 101, the negative electrode 102, the electrolytic solution 103 on the air electrode side, the electrolytic solution 104 on the negative electrode side, and the ion exchange membrane 105. The electrolytic solutions 103 and 104 in this case are aqueous solutions containing an ion conductor, and the electrolytic solution 104 is an electrolytic solution in which a surfactant is dissolved. Further, an air electrode case 201 is disposed on the air electrode side, and a negative electrode case 202 is disposed on the negative electrode side. The air electrode case 201 has an opening 201a, so that ambient air can be brought into contact with the air electrode 101.

Also, the air electrode case 201 and the negative electrode case 202 are fitted to each other, and a gasket 203 is disposed at the fitted portion. The electrolytic solution 103 on the air electrode side, the ion exchange membrane 105, and the electrolytic solution 104 on the negative electrode side are interposed between the air electrode 101 and the negative electrode 102, and these components constitute a battery cell. This battery cell is disposed between the air electrode case 201 and the negative electrode case 202, and the air electrode case 201 and the negative electrode case 202 are fitted to each other and are thus integrated.

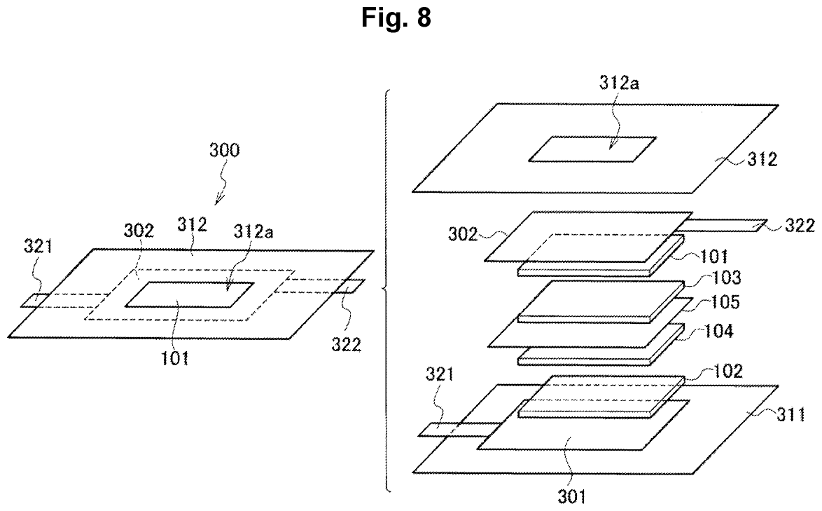

As illustrated in FIG. 8, a housing 300 that seals the inside of the battery cell, excluding the air electrode 101, may be used to house the battery cell in the housing 300. The housing 300 includes a first housing 311 disposed on the side of the negative electrode 102, and a second housing 312 disposed on the side of the air electrode 101. An opening 312a is formed in the second housing 312 so that ambient air can come into contact with the air electrode 101.

A negative-electrode current collector 301 is provided between the first housing 311 and the negative electrode 102, an air-electrode current collector 302 is provided between the second housing 312 and the air electrode 101, and terminals 321 and 322 are drawn out of the housing 300 from the respective current collectors. Note that, in a case where a metal is used as the negative electrode 102, the terminal may be directly drawn out from the negative electrode 102 to the outside, without the use of the negative-electrode current collector 301.

Also, the housing 300 should be formed with a material that can maintain the battery cell inside, and spontaneously decomposes. The housing 300 may be formed with any material of a natural product type, a microbial type, and a synthetic type, and can be formed with polylactic acid, polycaprolactone, polyhydroxyalkanoate, polyglycolic acid, modified polyvinyl alcohol, casein, modified starch, or the like, for example. Particularly, a synthetic product such as plant-derived polylactic acid is preferable. Also, the shape of the housing 300 is not limited, as long as the shape is obtained by processing biodegradable plastic. Examples of materials that can be used for the housing 300 include a paper sheet that has a coating film of a resin such as polyethylene formed thereon and is used for milk packages or the like, and an agar film, in addition to a commercially available biodegradable plastic film.

The first housing 311 and the second housing 312 formed with the above-described material are bonded to each other at an edge portion, so that the inside of the battery cell excluding the air electrode 101 can be sealed. Examples of bonding methods include methods using thermal sealing or an adhesive, and are not limited to any particular methods. It is preferable to use an adhesive formed with a biodegradable resin. Note that the shapes of the air electrode 101, the negative electrode 102, the electrolytic solutions 103 and 104, the first housing 311, the second housing 312, the negative-electrode current collector 301, and the air-electrode current collector 302 are not limited, as long as the layout of them for operating as a battery is not impaired. For example, those components can be used in a quadrangular or circular sheet-like shape or a rolled shape in a planar view.

When used in a disposable device such as a soil moisture sensor, for example, a metal-air battery in the housing 300 formed with the spontaneously decomposable material described above spontaneously decomposes over time, and there is no need to recover the battery. Further, as the housing is formed with a nature-based material or a fertilizer component, the impact on the environment is extremely low.

### Example 1 (an Example of a Ketjen Black Air Electrode)

First, Example 1 is described. In Example 1, carbon (Ketjen Black EC600JD) known as an electrode was used for the air electrode, and the effects of ion exchange membranes were examined.

As the ion exchange membranes, three kinds of ion exchange membranes of Selemion, Neosepta, and Nafion were prepared, and each of the ion exchange membranes was cut out into a circle having a diameter of 15 mm. Ketjen black powder (manufactured by Lion Corporation) of carbon (Ketjen Black EC600JD) and polytetrafluoroethylene (PTFE) powder (manufactured by Daikin Industries, Ltd.) were sufficiently pulverized and mixed at a weight ratio of 80:20 with a mortar machine, and were subjected to roll molding, to form a sheet-like electrode (thickness: 0.6 mm). This sheet-like electrode was cut out into a circle having a diameter of 14 mm, and thus, the air electrode was obtained. The negative electrode was prepared by cutting out a commercially available magnesium alloy AZ31 plate (thickness: 200 μm, manufactured by The Nilaco Corporation) into a circle having a diameter of 14 mm with a punching blade, a laser cutter, or the like.

As for the electrolytic solutions, a sodium chloride (NaCl, manufactured by Kanto Chemical Co., Inc.) was dissolved in pure water at a concentration of 1 mol/L, to obtain an electrolytic solution a on the air electrode side. Further, the solutions obtained by dissolving a surfactant (Triton X-100) in the electrolytic solution a at concentrations shown in Table 1 were defined as electrolytic solutions b1 to b4, respectively. The respective concentrations of the electrolytic solutions b1 to b4 are 5×10⁻⁵ mol/L, 1×10⁻⁴ mol/L, 5×10⁻⁴ mol/L, and 1×10⁻³ mol/L.

TABLE 1

| | |
|---|---|
| Electrolytic solution b1 | 5 × 10⁻⁵ mol/L |
| Electrolytic solution b2 | 1 × 10⁻⁴ mol/L |
| Electrolytic solution b3 | 5 × 10⁻⁴ mol/L |
| Electrolytic solution b4 | 1 × 10⁻³ mol/L |

The air electrode, the negative electrode, the electrolytic solutions, and the ion exchange membranes described above were used to produce a coin-cell magnesium-air battery described with reference to FIG. 7. First, the air electrode was placed on an air electrode case in which the edge portion of a copper mesh foil (manufactured by MIT Japan) was fixed to the inside by spot welding. Also, as for the negative electrode formed with a metallic magnesium plate, the edge portion was fixed to a copper mesh foil (manufactured by MIT Japan) by spot welding, and the copper mesh foil was fixed to a negative electrode case by spot welding.

After 2 ml of the electrolytic solution a was dropped onto the air electrode set in the air electrode case, an ion exchange membrane was placed, a cellulose-based separator for batteries (manufactured by Nippon Kodoshi Corporation) cut into a circle having a diameter of 14 mm was further placed. After that, 2 ml of the electrolytic solution b was dropped thereonto.

In Example 1, three types of ion exchange membranes, which are Selemion, Neosepta, and Nafion, are used. Also, as the electrolytic solution b, four kinds of electrolytic solutions b1 to b4 in which the surfactant is dissolved in the electrolytic solution a at respective concentrations shown in Table 1 are used. Thus, in Example 1, 12 magnesium-air batteries are manufactured.

Next, the air electrode case was covered with the negative electrode case to which the negative electrode was fixed, and the edge portions of the air electrode case and the negative electrode case were swaged with a coin cell swaging tool, to prepare coin-cell magnesium-air batteries each including a polypropylene gasket.

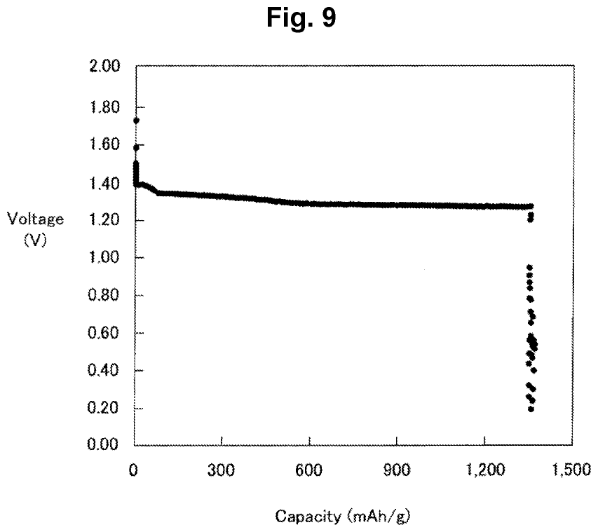

The battery performance of each of the prepared coin-cell magnesium-air batteries was measured. First, a discharge test was conducted. In the discharge test on the magnesium-air batteries, a commercially available charge/discharge measurement system (SD8 Charge/Discharge System, manufactured by Hokuto Denko Corporation) was used, and 0.1 mA/cm² was applied at a current density per effective area of the air electrode. Measurement was then performed until the battery voltage dropped from the open circuit voltage to 0 V. In the discharge test, measurement was carried out in a thermostatic chamber at 25° C. (atmosphere: an ordinary living environment). A discharge capacity was represented by a value (mAh/g) per weight of the air electrode. A discharge curve in Example 1 (the ion exchange membrane is Neosepta, with the electrolytic solution b2) is shown in FIG. 9.

As can be seen from FIG. 9, the average discharge voltage is 1.3 V, and the discharge capacity is 1360 mAh/g. Note that the average discharge voltage is the battery voltage at a discharge capacity (680 mAh/g in Example 1), which is ½ of the discharge capacity (1360 mAh/g herein) of the battery.

Table 2 below shows the discharge capacities of the 12 magnesium-air batteries obtained by combining the three kinds of ion exchange membranes of Nafion, Neosepta, and Selemion with the four kinds of electrolytic solutions b1 to b4 as the electrolytic solution b.

TABLE 2

| Ion | | Discharge |
|---|---|---|
| exchange | | capacity |
| membrane | Electrolytic solution | (mAh /g) |
| Nafion | Electrolytic solution b1 | 1350 |
| | Electrolytic solution b2 | 1400 |
| | Electrolytic solution b3 | 1440 |
| | Electrolytic solution b4 | 1460 |
| Neosepta | Electrolytic solution b1 | 1310 |
| | Electrolytic solution b2 | 1360 |
| | Electrolytic solution b3 | 1400 |
| | Electrolytic solution b4 | 1420 |
| Selemion | Electrolytic solution b1 | 1270 |
| | Electrolytic solution b2 | 1320 |
| | Electrolytic solution b3 | 1360 |
| | Electrolytic solution b4 | 1380 |

In any case, the discharge capacity was 1200 mAh/g or higher, which was greater than that of Comparative Example 1 in which any ion exchange membrane was not used as described later.

The electrolytic solution containing the surfactant reduces corrosion reactions of the negative electrode, the reaction time becomes longer, and the ion exchange membrane can prevent the surfactant from not reaching the air electrode and the air electrode from being hydrophilized and submerged. It is considered that, because of this, oxygen was supplied to the air electrode for a long time, and the discharge capacity was enhanced. In any of the ion exchange membranes, the influence of overvoltage due to the resistance of ion conduction was small, and the battery performance was improved.

### Example 2 (an Example of an Air Electrode of a Nanosheet Co-Continuous Body)

Next, Example 2 is described. Example 2 is an example in which a co-continuous body using nanosheets is used as the air electrode. The co-continuous body has a three-dimensional network structure formed with a plurality of nanosheets integrated by non-covalent bonding.

The air electrode was synthesized as follows. In the description below, a manufacturing method using graphene as nanosheets will be described as a typical example, but the co-continuous body having a three-dimensional network structure can be adjusted by changing graphene to nanosheets of some other material. Note that the degrees of porosity shown below were calculated by modeling fine pores as cylindrical shapes from a pore size distribution obtained by calculating a co-continuous body by a mercury intrusion technique. Magnesium-air batteries were manufactured, and a discharge test was conducted in the same manners as those in Example 1.

First, a commercially available graphene sol [dispersion medium: water (H₂O), 0.4 wt %, silicon “manufactured by Sigma-Aldrich Co. LLC” was placed in a test tube, and the test tube was immersed in liquid nitrogen for 30 minutes, to completely freeze the graphene sol. After the graphene sol was completely frozen, the frozen graphene sol was taken out and was put into an eggplant flask. The frozen graphene sol was then dried in a vacuum of 10 Pa or lower with a freeze dryer (manufactured by Tokyo Rikakikai Co., Ltd.), to obtain a stretchable co-continuous body having a three-dimensional network structure containing graphene nanosheets.

The obtained co-continuous body was evaluated through X-ray diffraction (XRD) measurement, scanning electron microscope (SEM) observation, porosity measurement, a tensile test, and BET specific surface area measurement. The co-continuous body prepared in this embodiment was confirmed to be a carbon (C, PDF Card No. 01-075-0444) single phase by the XRD measurement. Note that the PDF Card No. is a card number in Powder Diffraction File (PDF), which is a database constructed by the International Centre for Diffraction Data (ICDD), and the same applies in the description below.

Also, it was confirmed by the SEM observation and a mercury intrusion technique that the obtained co-continuous body was a co-continuous body in which nanosheets (graphene pieces) were continuously present, with the average pore size being 1 μm. Further, the BET specific surface area of the co-continuous body was measured by the mercury intrusion technique, and was found to be 510 m²/g. Also, the degree of porosity of the co-continuous body was measured by the mercury intrusion technique, and was found to be 90% or higher. Furthermore, from the results of the tensile test, it was confirmed that the obtained co-continuous body did not exceed the elastic region, and restored to the shape before stress application, even when a strain of 20% was applied by a tensile stress.

Such a co-continuous body formed with graphene was cut into a circle having a diameter of 14 mm with a punching blade, a laser cutter, or the like, to obtain a gas-diffusion air electrode.

The negative electrode was prepared by cutting out a commercially available magnesium alloy AZ31 plate (thickness: 200 μm, manufactured by The Nilaco Corporation) into a circle having a diameter of 14 mm with a punching blade, a laser cutter, or the like. As for the electrolytic solutions, a sodium chloride (NaCl, manufactured by Kanto Chemical Co., Inc.) was dissolved in pure water at a concentration of 1 mol/L, to obtain the electrolytic solution a. Further, the solution obtained by dissolving 5×10−4 mol/L of the surfactant (Triton X-100) in the electrolytic solution a was used as the electrolytic solution b3.

Battery performance of coin-cell air batteries was observed in the same manner as in Example 1, and the battery performance was evaluated. Nafion was used for the ion exchange membrane.

Table 3 below shows the discharge capacities of magnesium-air batteries in which co-continuous bodies were formed as the air electrodes from nanosheets of graphene (C), iron oxide (Fe₂O₃), manganese oxide (MnO₂), zinc oxide (ZnO), molybdenum oxide (MoO₃), and molybdenum sulfide (MoS₂). As for the graphene in Example 2, the discharge capacity was 1450 mAh/g, which was higher than the value in the case where the air electrode formed with a commercially available carbon (Ketjen Black EC600JD) in Example 1 (Nafion, electrolytic solution b3).

TABLE 3

| Nanosheet material | Discharge capacity (mAh/g) |
|---|---|
| Graphene (C) | 1450 |
| Iron oxide (Fe₂O₃) | 1440 |
| Manganese oxide (MnO₂) | 1490 |
| Zinc oxide (ZnO) | 1440 |
| Molybdenum oxide (MoO₃) | 1380 |
| Molybdenum sulfide (MoS₂) | 1380 |

### Example 3 (an Example of an Air Electrode of a Nanofiber Co-Continuous Body)

Next, Example 3 is described. Example 3 is an example in which a co-continuous body using nanofibers is used as the air electrode. The co-continuous body has a three-dimensional network structure formed with a plurality of nanofibers integrated by non-covalent bonding.

The air electrode was synthesized as follows. In the description below, a manufacturing method using carbon nanofibers will be described as a typical example, but the co-continuous body having a three-dimensional network structure can be adjusted by changing carbon nanofibers to nanosheets of some other material.

Co-continuous bodies were evaluated, magnesium-air batteries were manufactured, and a discharge test was conducted in the same manners as those in Examples 1 and 2.

A co-continuous body was prepared in the same manner as in the process described in Example 2, and a carbon nanofiber sol [dispersion medium: water (H₂O), 0.4 wt %, manufactured by Sigma-Aldrich Co. LLC] was used as the raw material.

The obtained co-continuous body was evaluated through XRD measurement, SEM observation, porosity measurement, a tensile test, and BET specific surface area measurement. The co-continuous body prepared in this embodiment was confirmed to be a carbon (C, PDF Card No. 00-058-1638) single phase by the XRD measurement. Also, it was confirmed by the SEM observation and a mercury intrusion technique that the obtained co-continuous body was a co-continuous body in which nanofibers were continuously present, with the average pore size being 1 μm. Further, the BET specific surface area of the co-continuous body was measured by the mercury intrusion technique, and was found to be 620 m²/g. Also, the degree of porosity of the co-continuous body was measured by the mercury intrusion technique, and was found to be 93% or higher. Furthermore, from the results of the tensile test, it was confirmed that the co-continuous body of Example 3 did not exceed the elastic region, and restored to the shape before stress application, even when a strain of 40% was applied by a tensile stress.

A coin-cell magnesium-air battery similar to that of Example 2 was manufactured, the co-continuous body formed with carbon nanofibers being used as the air electrode. Specifically, in Example 3, Nafion was used for the ion exchange membrane, and the electrolytic solution b3 was used. The discharge capacities of magnesium-air batteries manufactured in Example 3 are shown in Table 4.

TABLE 4

| Nanofiber material | Discharge capacity (mAh/g) |
|---|---|
| Carbon nanofiber (C) | 1480 |
| Iron oxide (Fe₂O₃) | 1470 |
| Manganese oxide (MnO₂) | 1520 |
| Zinc oxide (ZnO) | 1470 |
| Molybdenum oxide (MoO₃) | 1410 |
| Molybdenum sulfide (MoS₂) | 1410 |

With the carbon nanofibers (C) of Example 3, the discharge capacity was 1480 mAh/g, which was higher than that in the case where a co-continuous body formed with graphene of Example 2 was used. Such improvement of characteristics was achieved, supposedly because a smooth reaction was made during discharging with the co-continuous body having a higher stretchability.

Table 4 shows the discharge capacities of magnesium-air batteries in which co-continuous bodies were formed as the air electrodes from carbon nanofibers (C), iron oxide (Fe₂O₃), manganese oxide (MnO₂), zinc oxide (ZnO), molybdenum oxide (MoO₃), and molybdenum sulfide (MoS₂).

In any case, the discharge capacity was 1400 mAh/g or higher, which was entirely a greater value than that of a co-continuous body containing nanosheets as in Example 2. In the case of these nanofibers, the air electrode having stretchability also efficiently precipitated a discharge product [Mg(OH)₂], and thus, the discharge capacity was improved, as in the case of carbon nanofibers.

### Example 4 (an Example in which a Co-Continuous Body of Cellulose Produced by Bacteria is Used as an Air Electrode)

Next, Example 4 is Described. Example 4 is an Example in which a co-continuous body formed with a gel in which cellulose produced by bacteria is dispersed is used as an air electrode. Co-continuous bodies were evaluated, magnesium-air batteries were manufactured, and a discharge test was conducted in the same manners as those in Examples 1, 2, and 3.

First, a coin-cell magnesium-air battery similar to that of Example 2 was prepared, using Nata De Coco (manufactured by Fujicco Co., Ltd.) as a bacterium cellulose gel produced by Acetobacter xylinum that are acetic acid bacteria. Specifically, in Example 4, Nafion was used for the ion exchange membrane, and the electrolytic solution b3 was used. Note that, in Example 4, after dried in vacuum, a co-continuous body was carbonized through burning in a nitrogen atmosphere at 1200° C. for 2 hours, to form an air electrode.

The obtained co-continuous body (the carbonized co-continuous body) was evaluated through XRD measurement, SEM observation, porosity measurement, a tensile test, and BET specific surface area measurement. This co-continuous body was confirmed to be a carbon (C, PDF Card No. 01-071-4630) single phase by the XRD measurement. Also, it was confirmed by the SEM observation that the obtained co-continuous body was a co-continuous body in which nanofibers of 20 nm in diameter were continuously present. Further, the BET specific surface area of the co-continuous body was measured by a mercury intrusion technique, and was found to be 830 m²/g. Also, the degree of porosity of the co-continuous body was measured by the mercury intrusion technique, and was found to be 99% or higher. Furthermore, from the results of the tensile test, it was confirmed that the obtained co-continuous body did not exceed the elastic region, and restored to the shape before stress application, even when a strain of 80% was applied by a tensile stress. After the carbonization, the co-continuous body maintains an excellent stretchability.

The discharge capacity of a magnesium-air battery in Example 4 is shown below in Table 5. Table 5 also shows the results of Examples 1 (Nafion, the electrolytic solution b3), 2, and 3. In Example 4, the discharge capacity was 1910 mAh/g, and the performance was improved compared with Examples 1 to 3.

TABLE 5

| | Average | Discharge |
|---|---|---|
| | discharge voltage | capacity |
| Example | (V) | (mAh /g) |
| Example 1 (Ketjen black) | 1.3 | 1440 |
| Example 2 (graphene) | 1.2 | 1450 |
| Example 3 (carbon nanofiber) | 1.2 | 1480 |
| Example 4 (carbonized bacteria cellulose) | 1.3 | 1910 |

The above improvement of the characteristics was achieved, supposedly because a discharge product [Mg(OH)₂] was efficiently precipitated during discharging with a co-continuous body having a higher stretchability, and carbon (C) has an excellent conductivity to facilitate a smooth reaction.

As described above, in this example, a co-continuous body having a high degree of porosity and stretchability is obtained through BET specific surface area measurement. Also, with a magnesium-air battery using this co-continuous body as the air electrode, efficient precipitation of a discharge product [Mg(OH)₂] during discharging is realized. The improvement of the characteristics described above was achieved, supposedly because various kinds of improvements were made in this embodiment.

### Example 5 (an Example of a Ketjen Black Air Electrode and a Zinc Negative Electrode)

In Example 5, carbon (Ketjen Black EC600JD) known as an electrode for an air electrode was used, and the metal for the negative electrode was changed to zinc (thickness: 200 μm, manufactured by The Nilaco Corporation). A battery of Example 5 was manufactured, and a discharge test was conducted in the same manners as those in Example 1. Specifically, in Example 5, Nafion was used for the ion exchange membrane, and the electrolytic solution b3 was used.

Table 6 shows the discharge capacity and the voltage of a zinc-air battery according to Example 5. Table 6 also shows the results of Example 1 (Nafion, the electrolytic solution b3).

TABLE 6

| | Average | Discharge |
|---|---|---|
| | discharge voltage | capacity |
| Example | (V) | (mAh/g) |
| Example 1 (Ketjen black) | 1.3 | 1440 |
| Example 5 (Ketjen black) | 1.1 | 1130 |

The discharge capacity in Example 5 was 1130 mAh/g, and the voltage was about 1.1 V, which were smaller values than those of a magnesium-air battery using a magnesium alloy AZ31 plate in Example 1.

The difference in characteristics as described above is considered to be the influence of the readiness of dissolution in an electrolytic solution due to the ionization tendency of the metal. Specifically, this is supposedly because, in a case where zinc is used for the negative electrode, the efficiency of use of electrons generated during the dissolution of the negative electrode metal for battery reactions is lower than that in a case where a magnesium alloy AZ31 plate is used. However, the discharge capacity and the voltage in Example 5 were higher than those in Comparative Example 3 in which any ion exchange membrane was not used as described later.

As described above, in this example, a magnesium alloy AZ31 plate was used for the negative electrode of a metal-air battery, so that the most efficient electron flow was achieved at the time of discharging. However, even when zinc was used, the effect to improve the discharge capacity and the voltage was observed, because an ion exchange membrane was used.

### Comparative Example 1

Next, Comparative Example 1 is described. In Comparative Example 1, carbon (Ketjen Black EC600JD) known as electrodes for air electrodes was used in manufacturing magnesium-air batteries under the conditions shown in Table 7, and the magnesium-air batteries were evaluated.

TABLE 7

| | | Ion exchange |
|---|---|---|
| | Electrolytic solution | membrane |
| Condition 1 | Electrolytic solution b2 | N/A |
| Condition 2 | 1 mol/L NaCl solution | Neosepta |
| Condition 3 | 1 mol/L NaCl solution | N/A |

Condition 1 in Comparative Example 1 is that the electrolytic solution b2 of Example 1 is used as the electrolytic solution on the negative electrode side, and a magnesium-air battery does not include any ion exchange membrane. The electrolytic solution b2 was obtained by dissolving a surfactant (Triton X-100) at a concentration of 1×10⁻⁴ mol/L in the electrolytic solution a obtained by dissolving sodium chloride (NaCl, manufactured by Kanto Chemical Co., Inc.) at a concentration of 1 mol/L in pure water.

Condition 2 in Comparative Example 1 is that the electrolytic solution a obtained by dissolving sodium chloride (NaCl, manufactured by Kanto Chemical Co., Inc.) in pure water at a concentration of 1 mol/L is used as the electrolytic solution on the negative electrode side, and a magnesium-air battery includes an ion exchange membrane formed with Neosepta. The electrolytic solution on the negative electrode side under Condition 2 does not contain any surfactant.

Condition 3 in Comparative Example 1 is that the electrolytic solution a obtained by dissolving sodium chloride (NaCl, manufactured by Kanto Chemical Co., Inc.) in pure water at a concentration of 1 mol/L is used as the electrolytic solution on the negative electrode side, and a magnesium-air battery does not include any ion exchange membrane. The electrolytic solution on the negative electrode side under Condition 2 does not contain any surfactant.

Table 8 shows the discharge capacities and the voltages of magnesium-air batteries of Comparative Example 1. Table 8 also shows the results of Example 1 (Nafion, the electrolytic solution b3).

TABLE 8

| | Average | Discharge |
|---|---|---|
| | discharge voltage | capacity |
| | (V) | (mAh /g) |
| Example 1 | 1.3 | 1440 |
| Comparative Example 1, Condition 1 | 1.1 | 1210 |
| Comparative Example 1, Condition 2 | 1.3 | 1020 |
| Comparative Example 1, Condition 3 | 1.3 | 1030 |

The voltage of the magnesium-air battery under Condition 1 in Comparative Example 1 was 1.1 V, and the discharge capacity was 1210 mAh/g, which were smaller than those in Example 1. In the magnesium-air battery under Condition 1, the discharge capacity was improved as compared with those under Condition 2 and Condition 3 not involving any surfactant, but the voltage was lower.

From the above results, it was confirmed that a metal-air battery of this embodiment is superior in capacity and voltage to a metal-air battery using no ion exchange membrane.

### Comparative Example 2

Next, Comparative Example 2 is described. In Comparative Example 2, co-continuous bodies formed with a gel in which cellulose produced by bacteria was dispersed were used as electrodes for the air electrodes, and magnesium-air batteries were manufactured under the conditions shown above in Table 7, and were evaluated.

Table 9 shows the discharge capacities and the voltages of magnesium-air batteries of Comparative Example 2. Table 9 also shows the results of Example 4.

TABLE 9

| | Average | Discharge |
|---|---|---|
| | discharge voltage | capacity |
| | (V) | (mAh /g) |
| Example 4 | 1.3 | 1910 |
| Comparative Example 2, Condition 1 | 1.1 | 1700 |
| Comparative Example 2, Condition 2 | 1.3 | 1430 |
| Comparative Example 2, Condition 3 | 1.3 | 1450 |

The voltage of the magnesium-air battery under Condition 1 in Comparative Example 2 was 1.1 V, and the discharge capacity was 1700 mAh/g, which were smaller than those in Example 4. In the magnesium-air battery under Condition 1, the discharge capacity was improved as compared with those under Condition 2 and Condition 3 not involving any surfactant, but the voltage was lower.

From the above results, it was confirmed that, even in a case where a co-continuous body formed with a gel in which cellulose produced by bacteria is dispersed is used as the electrode for the air electrode, a metal-air battery of this embodiment is superior in capacity and voltage to a metal-air battery not using any ion exchange membrane.

### Comparative Example 3

Next, Comparative Example 3 is described. In Comparative Example 3, carbon (Ketjen Black EC600JD) known as electrodes for air electrodes was used in manufacturing zinc-air batteries under the conditions shown above in Table 7, and the zinc-air batteries were evaluated.

Table 10 shows the discharge capacities and the voltages of zinc-air batteries of Comparative Example 3. Table 10 also shows the results of Example 5.

TABLE 10

| | Average | Discharge |
|---|---|---|
| | discharge voltage | capacity |
| | (V) | (mAh /g) |
| Example 5 | 1.1 | 1130 |
| Comparative Example 3, Condition 1 | 0.9 | 980 |
| Comparative Example 3, Condition 2 | 1.1 | 820 |
| Comparative Example 3, Condition 3 | 1.1 | 830 |

The voltage of the zinc-air battery under Condition 1 in Comparative Example 3 was 0.9 V, and the discharge capacity was 980 mAh/g, which were smaller than those in Example 5. In the zinc-air battery under Condition 1, the discharge capacity was improved as compared with those under Condition 2 and Condition 3 not involving any surfactant, but the voltage was lower.

From the above results, it was confirmed that, even in a case where zinc is used for the negative electrode, a metal-air battery of this embodiment is superior in capacity and voltage to a metal-air battery using no ion exchange membrane.

A metal-air battery of this embodiment described so far includes: an air electrode 101; a negative electrode 102; an ion exchange membrane 105 that separates the air electrode 101 and the negative electrode 102 from each other; an air-electrode-side electrolytic solution 103 that is disposed between the air electrode 101 and the ion exchange membrane 105; and a negative-electrode-side electrolytic solution 104 that is disposed between the negative electrode 102 and the ion exchange membrane 105. The negative-electrode-side electrolytic solution 104 contains a surfactant.

As described above, in the metal-air battery of this embodiment, a surfactant is added only to the electrolytic solution 104 on the side of the negative electrode 102, and the ion exchange membrane 105 that reduces diffusion of the surfactant is provided between the electrolytic solution 104 and the electrolytic solution on the side of the air electrode 101.

While corrosion reactions of the negative electrode 102 is reduced by the effects of the surfactant, the surfactant does not permeate the ion exchange membrane 105. Thus, it is possible to prevent the air electrode 101 from being hydrophilized and submerged. Accordingly, the metal-air battery of this embodiment can improve its battery performance by reducing corrosion reactions of the negative electrode 102 while minimizing the influence on the air electrode 101.

Note that the present invention is not limited to the above embodiments, and various modifications and combinations are possible within the technical idea of the present invention.

### REFERENCE SIGNS LIST

101 air electrode
102 negative electrode
103 electrolyte on the air electrode side
104 electrolyte on the negative electrode side
105 ion exchange membrane

1. A metal-air battery comprising:
an air electrode;
a negative electrode;
an ion exchange membrane that separates the air electrode and the negative electrode from each other;
an air-electrode-side electrolytic solution that is disposed between the air electrode and the ion exchange membrane; and
a negative-electrode-side electrolytic solution that is disposed between the negative electrode and the ion exchange membrane,
wherein the negative-electrode-side electrolytic solution contains a surfactant.

2. The metal-air battery according to claim 1, wherein the ion exchange membrane contains at least two kinds of atoms selected from the group consisting of carbon atoms, hydrogen atoms, oxygen atoms, nitrogen atoms, sulfur atoms, sodium atoms, potassium atoms, and phosphorus atoms.

3. The metal-air battery according to claim 1, wherein the negative electrode contains at least one element selected from the group consisting of magnesium, zinc, aluminum, iron, and calcium.

4. The metal-air battery according to claim 1, wherein the air electrode includes a co-continuous body that has a three-dimensional network structure in which a plurality of nanostructures is integrated by non-covalent bonding.

5. The metal-air battery according to claim 2, wherein the negative electrode contains at least one element selected from the group consisting of magnesium, zinc, aluminum, iron, and calcium.

6. The metal-air battery according to claim 2, wherein the air electrode includes a co-continuous body that has a three-dimensional network structure in which a plurality of nanostructures is integrated by non-covalent bonding.

7. The metal-air battery according to claim 3, wherein the air electrode includes a co-continuous body that has a three-dimensional network structure in which a plurality of nanostructures is integrated by non-covalent bonding.
